(19) United States
(12) Patent Application Publication
(10) Pub. No.: US 2007/0036127 A1
(43) Pub. Date: Feb. 15, 2007

(54) Ip-based call establishment

(75) Inventors: Kurt Roosen, Ballasalla (GB); Michael Bromwich, Port Erin (GB)

Correspondence Address: SUGHRUE MION, PLLC, 2100 PENNSYLVANIA AVENUE, N.W., SUITE 800, WASHINGTON, DC, 20037, US

(73) Assignee: CALLKEY LIMITED, Isle of Man (GB)

(21) Appl. No.: 10/564,723

(22) PCT Filed: Jul. 16, 2004
(86) PCT No.: PCT/GB04/03125

§ 371 Date: Jul. 5, 2006

(30) Foreign Application Priority Data
Jul. 16, 2003 (GB) 0316648.5

(51) Int. Cl. H04L 12/66

(52) U.S. Cl. 370/352

(57) ABSTRACT

There is disclosed a communication system adapted to establishing a communication between at least two end-points, comprising: a control server for receiving a request including an identifier of a calling number of one end-point and an identifier of an action, and adapted to transmit said request in XML format in dependence upon said action, a switching control server for receiving the request in XML format; an IP router operating under the control of SIP messages from the switching control server; the IP router being controlled for establishing a first communication link to the calling number of the one end-point; wherein the switching controller further controls the IP router to connect the established communication link to the other end-point.

The present invention relates to a technique for establishing a telephone connection between at least two end-points. The invention is particularly, but not exclusively, concerned with establishing telephone calls between parties.

Access to traditional long-distance telephone services is strictly limited to countries of origin. International phone rates vary from country to country, and are dependent on factors such as competition. Mobile telephone users may roam outside their home country, but usually pay a roaming charge plus expensive long-distance rates.

Although there exists, in many countries, strong competition for the provision of long-distance telephone services, the current best rates for various countries may be provided by different carriers. For example, for a call made from the UK the best long-distance rate to Australia may be offered by one carrier, and the best long-distance rate to Brazil offered by another, different carrier. Thus a customer may have to research every telephone call to get the best rate. Furthermore, carriers are typically associated with one type of call. A carrier that offers the best rate for a call from the UK to Australia may only do so for fixed line calls, and mobile telephone users may not be provided with low rate calls.

There have been proposed various techniques for providing low-cost, best-cost, telephone services on an automated basis.

There exists techniques for establishing long-distance voice communications using the Internet. U.S. Pat. No. 6,188,683 discloses a technique for establishing long-distance telephone calls over the public switched telephone network using an automated Internet operator. The system includes a long-distance service provider node connected to the Internet, and a call connection control computer connected to the Internet and interfaced to a toll switch connected to the PSTN. The method permits a calling party to request the automated Internet operator to complete long-distance call connections by connecting to the long-distance service provider node and identifying himself. The caller additionally provides the identity of a called party. A call connection control computer instructs the toll switch to dial the calling party, dial the called party, and then conference the two established lines. The conferencing of the two lines takes place in a PSTN toll switch. The call control computer is adapted to utilise a “least cost” routing algorithm to select an inter-exchange carrier for each call, depending on the origination and termination location of the call. All calls are established exclusively utilising an access to an Internet website.

The technique disclosed in U.S. Pat. No. 6,188,683 has two distinct drawbacks. Firstly, the connection of the two parties is by conferencing in a PSTN toll switch. When using a toll switch, a PSTN instrument is being instructed to establish the calls using traditional signalling, and then to perform blending, internally, of these carrier signals. This means that the conversations themselves can only exist within the toll switch. In addition, driving a PSTN switch requires use of a proprietary protocol devised by the switch vendor. This ties any solution to using such switches, and also makes it difficult to build a distributed architecture. Secondly, the billing of the established call is based on the cost of the call from one party to the other.

International patent application publication No. WO 02/078304 discloses a technique which is a modification of the technique disclosed in U.S. Pat. No. 6,188,683. Specifically, a call is established between two parties based on a request received in an electronic text message, rather than directly through a website. The connection again is established by creating a telephone call to each party, and then bridging each party in a point of presence switch.

This technique again disadvantageously utilises a PSTN switch, specifically a point of presence switch, to connect the lines established to each party to the call, and suffers the same drawbacks as U.S. Pat. No. 6,188,683. Further no suggestion is made to the modification of the billing technique proposed in the earlier U.S. patent.

International patent application publication No. WO 03/039181 discloses a technique which further improves on that disclosed in the two publications above. In this document there is proposed enhanced techniques associated with conference calls. Connections between parties to any call are still established by a PSTN point of presence switch, using a conference bridge as is well-known in the art. There is no suggestion that billing of such calls is anything other than conventional.

Thus the techniques known in the art allow for calls to be established using interfaces other than traditional dialling of a called number from a calling phone. Specifically the prior art generally allows calls to be established, for subscribers, using a website interface or an electronic text message. This does not, however, allow for all typical communication devices commonly in use to access the service.

Furthermore, the techniques known in the art establish call connections using traditional telecommunication switches, typically a switch of a PSTN. Thus the provision of services in the prior art is associated with all the technical disadvantages associated with traditional telecommunication switching.

It is an aim of the present invention to provide an improved technique for establishing a communication link between two points, which addresses one or more of the above-stated disadvantages.

According to the present invention there is provided a method of establishing a communication between at least two end-points, comprising: receiving an identifier of a calling number and an identifier of an action; establishing a communication link to the calling number; establishing a communication link in dependence on said action; and connecting the communication links in an IP domain.

The step of connecting the communication links may be performed by controlling an IP routing device. The IP routing device may establish a PSTN connection to the calling number.

The action may be to establish a telephone call to a called number, wherein the IP routing device establishes a PSTN connection to the called number and connects the established PSTN connections to the calling number and the called number in the IP domain. The IP routing device may be controlled to establish the PSTN connections to the calling party and the called party at terminals thereof, the IP routing device being further adapted to connect said terminals internally.

The action may be to access a streamed service, wherein the IP routing device connects the PSTN connection to the streamed service in the IP domain. The IP routing device may be controlled to establish the PSTN connection to the calling party, the IP routing device being further adapted to route said PSTN connection to a mixing server adapted to receive the streamed service.

The action may be to establish a PSTN connection to a plurality of called numbers, wherein the IP routing device connects the plurality of called numbers to the calling number in the IP domain. The IP routing device may be controlled to establish the PSTN connections to the calling party and the called parties at terminals thereof, the IP routing device being further adapted to route said connections to a mixing server in the IP domain.

The step of receiving an identifier of a calling number may comprise identifying the originating number of a request for the action. The step of receiving an identifier of a calling number may comprise extracting the calling number from a request for the action. The request may contain an identifier which maps to the calling number. The identifier of the action may comprise the called number, the method comprising extracting the called number from a request for the action. The request may contain an identifier which maps to the called number.

The request message may be received from any one of an e-mail client, a web client, an SMS client, a SOAP/HTTP client, or a WAP client.

The IP routing device is preferably controlled using SIP messages.

The method may further comprise receiving a request to establish a call connection at a web server, said request including the identifier of the calling number and the identifier of the action; verifying said request at the web server; transmitting said request in XML message format to a call controller controlling an IP router using SIP message, establishing the communication link to the calling number at the IP router under the control of the call controller.

The method may further comprise establishing the communication link to the called number at the IP router under the control of the call controller, and controlling the IP router to connect the established communication links internally.

The IP routing device may route said PSTN connection to a mixing server adapted to receive the streamed service.

The method may further comprise establishing communication links to the called numbers at the IP router under the control of the call controller, and controlling the IP router to connect the established communication links to a mixer in the IP domain, and mixing the established communication links under the control of the call controller.

In accordance with the present invention there is also provided a communication element adapted to establish a communication between at least two end-points, comprising: means adapted for receiving a request including an identifier of a calling number and an identifier of an action; means adapted for establishing a communication link to the calling number; means adapted for determining a communication link in dependence on said action; and means adapted for connecting the communication links in an IP domain.

The request may be an XML message, the means adapted for establishing a communication link to the calling number and the means adapted for connecting the communication links in an IP domain preferably comprising control means for transmitting SIP messages to an IP router.

If the action is to establish a call between a calling party and a called party, the SIP messages may instruct the IP router to establish a PSTN connection to each party and connect such connections internally.

If the action is to establish a call between a calling party and multiple called parties, the SIP messages may instruct the IP router to establish a PSTN connection to each party and route such connections to a mixer in the IP domain.

If the action is to establish a connection for the calling party to a streamed service, the SIP messages may instruct the IP router to establish a PSTN connection to the calling party and route such connections to a mixer in the IP domain adapted to receive the streamed service.

The element is preferably a switching server.

In a further aspect the present invention provides a communication element adapted to control the establishment of a communication between at least two end-points, comprising: means adapted for receiving a request including an identifier of a calling number and an identifier of an action; means adapted for verifying the request, and means adapted to transmit said request in XML format messages to an element for establishing the communication.

The request may comprise a message from any one of an e-mail client, a web client, an SMS client, a SOAP/HTTP client, or a WAP client

In a further aspect the present invention provides an IP router adapted to establish of a communication between at least two end-points, the router being adapted to establish a PSTN communication link to a first end-point, establish a communication link to a second end-point, and connect said established communications internally.

In a still further aspect the present invention provides a communication system adapted to establishing a communication between at least two end-points, comprising: a control server for receiving a request including an identifier of a calling number of one end-point and an identifier of an action, and adapted to transmit said request in XML format in dependence upon said action, a switching control server for receiving the request in XML format; an IP router operating under the control of SIP messages from the switching control server; the IP router being controlled for establishing a first communication link to the calling number of the one end-point; wherein the switching controller further controls the IP router to connect the established communication link to the other end-point.

In a further aspect of the present invention, there is provided a controlling point of presence and a switching point of presence, in which requests for establishment of communications are received at the controlling point of presence, and forwarded to the switching point of presence, the switching point of presence including means for establishing any required communication connection, and means for connecting the required communication connection in the IP domain.

In a further aspect, the present invention provides a method of establishing a telephone connection, in which a subscriber provides a recipient telephone number, a message is sent to the recipient telephone number, and responsive to receipt of a reply from the recipient telephone number a telephone call is established from the recipient telephone number, the cost of the call being charged to the subscriber. The message is preferably a SMS or text message. The call is preferably a call to a number provided by the subscriber, preferably the subscribers number. The method is preferably supported by an application server. The application server is preferably associated with a plurality of identifiers used for the purpose of identifying the origin of the text message. The text message sent to the recipient preferably uses one of said plurality of identifiers. The text message sent to the recipient preferably includes a unique identifier. The unique identifier preferably comprises the combination of the recipient number and one of the identifiers used for the purpose of identifying the origin of the text message. The reply from the recipient is preferably directed to the application server in dependence on the one of the identifiers used for the purpose of identifying the origin of the text message contained in the message sent to the recipient. The text message may invite the recipient to participate in a conference call. The application server may be a web server. The subscriber preferably provides the recipient number by way of a text message, the text message constituting a request for initiation of a text message to the recipient. The establishment of the telephone connection may be associated with the system and/or method defined anywhere in the present description as a whole. The method may be initiated by e-mail or url.

In a further aspect there is provided a method of billing for a telephone call, in which the telephone call is established by establishing a first telephone connection from a switching point to a calling party, establishing a second telephone connection from a switching point to a called party, and connecting the established telephone connections, wherein the cost of the call is dependent upon the cost of making a telephone call from the switching point to the respective parties. The switching points are preferably the same point. The switching points may be distinct switching points, interconnected, for example by an integrated backbone. Each switching point is preferably in a fixed geographical location. The cost of the call is based upon a first cost component being dependent upon the cost of a call from the geographical location of the switching point to the geographical location of the calling party, and a second cost component being dependent upon the cost of a call from the geographical location of the switching point and the geographical location of the called party. The first cost component may be adapted in dependence on the cost of making a telephone call from the geographical location of the calling party. The first cost component may be adapted in dependence on the cost of making a telephone call from the geographical location of the calling party to the switching point. The first cost component may be adapted in dependence on the cost of making a telephone call from the geographical location of the calling party to the geographical location of the called party.

The present invention thus provides an apparatus and method for establishing fixed and mobile telephony using a layered architecture over a distributed network. This approach tightly meshes data networks, for call control, with the existing public switched telephone network (PSTN) for call completion.

The system is designed to be independent of the source of user instructions. The initiation methods may be wide and varied, but are preferably not based on traditional telephony methods. User instructions are received at a controlling point of presence (POP). Control and data is consolidated at the controlling POP. A single controlling POP is provided in a preferred embodiment. Additional controlling POPs may be provided, being closely coupled for communication therebetween, for resilience (i.e. redundancy).

All calls preferably originate over a central switching point of presence (POP), which interconnects with wholesale long-distance carriers used for least cost routing. In embodiments, multiple switching POPs may be provided, with each call being directed to the most appropriate POP in accordance with system configuration settings and requirements.

In establishing a call between parties, each call consists of a minimum of two legs, one leg to the calling party and one leg to the called party. Thus the first leg is an inbound call to the user, and the second leg is an outbound call to the calling destination. Once both legs are in progress, they are connected to allow seamless communication. In such an implementation the parties constitute the end-points of the telephone connection. In a conference (n-way) call, multiple legs are established to connect multiple parties.

The invention may be further utilised to establish a connection between a party and a service provider, such as to allow a user to access music services, news services, voice mail services, etc. In such an implementation the calling party may be considered to be one end-point, and the service provider the other end-point.

The system advantageously allows discrete users to initiate and control voice communications independent of their local long-distance providers from any current location. Current modalities for call initiation advantageously include a web-page access, SMS messaging, a SOAP web service, e-mail access, and WAP services.

The invention will now be described in respect of a preferred embodiment with reference to the accompanying drawings, in which:

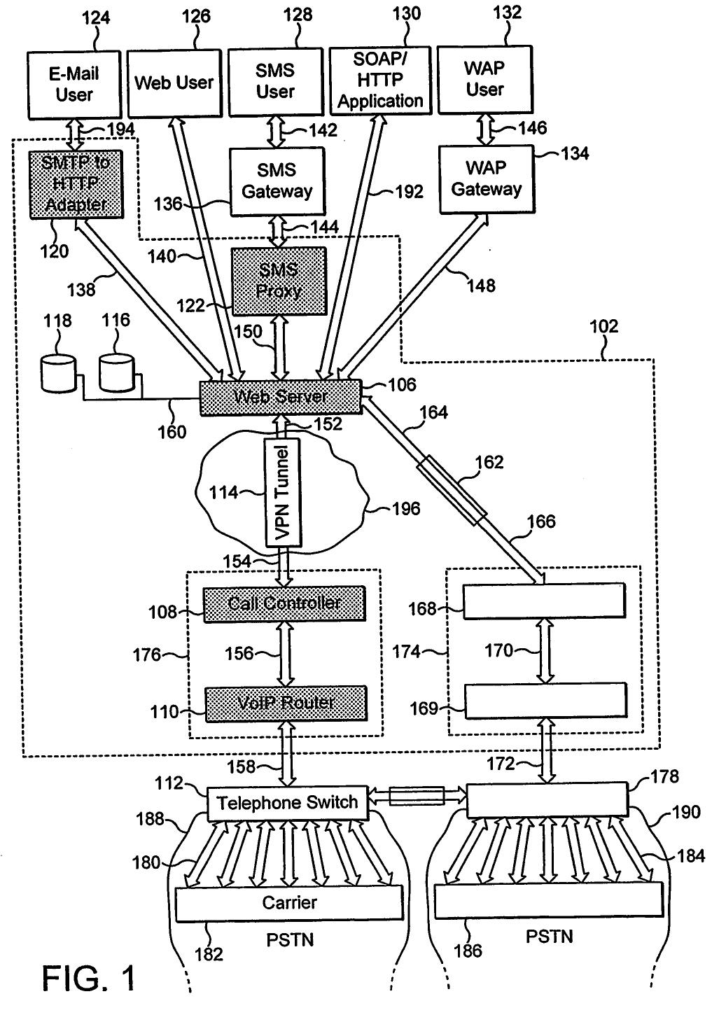

FIG. 1 illustrates the system architecture of a preferred embodiment;

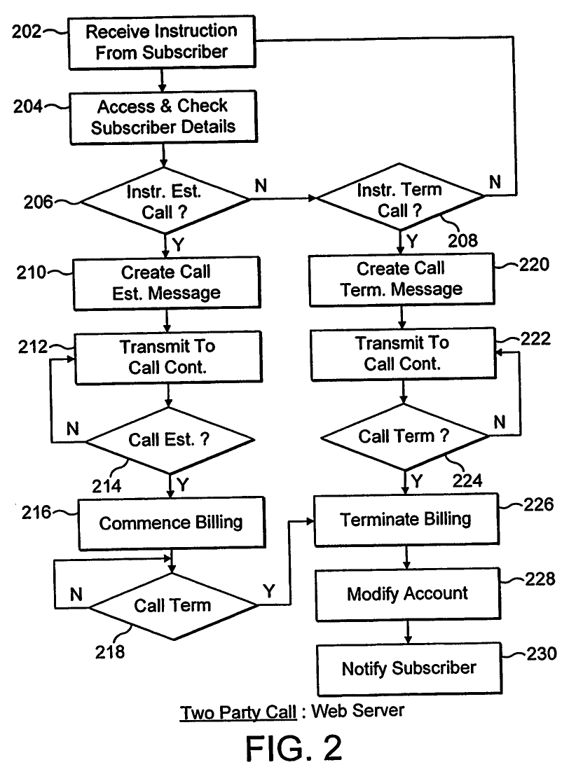

FIG. 2 illustrates the steps for establishing a two-party call at a web server in the architecture of FIG. 1 in accordance with the preferred embodiment;

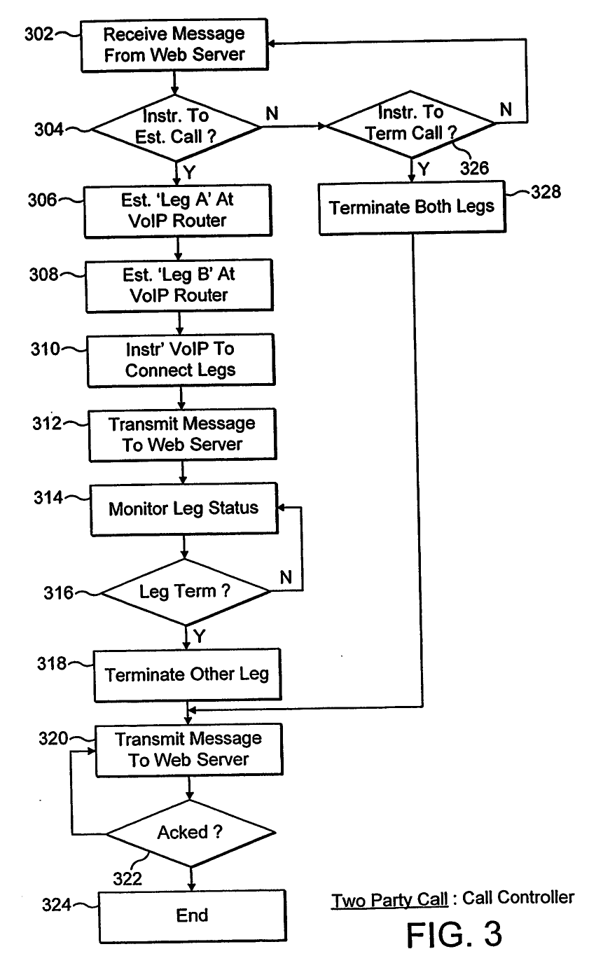

FIG. 3 illustrates the steps for establishing a two-party call at a call control server in the architecture of FIG. 1 in accordance with the preferred embodiment;

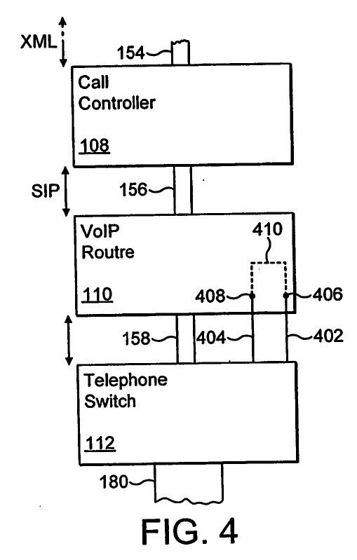

FIG. 4 illustrates in more detail the connection of a two-party call in the preferred system architecture of FIG. 1;

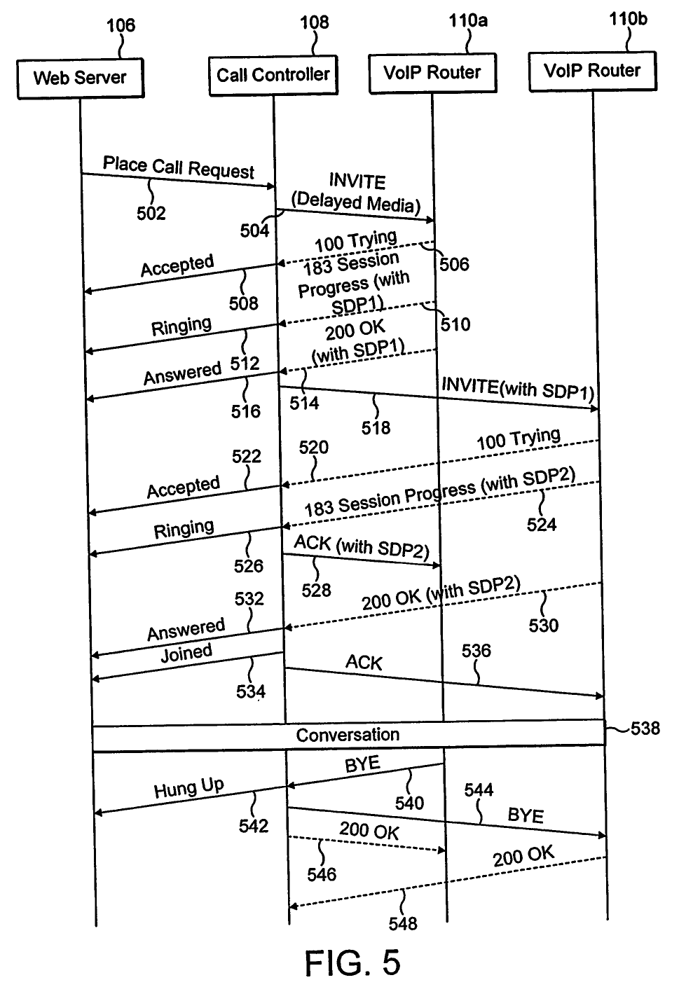

FIG. 5 illustrates the transmission of messages for establishing a two-party call in accordance with a preferred embodiment;

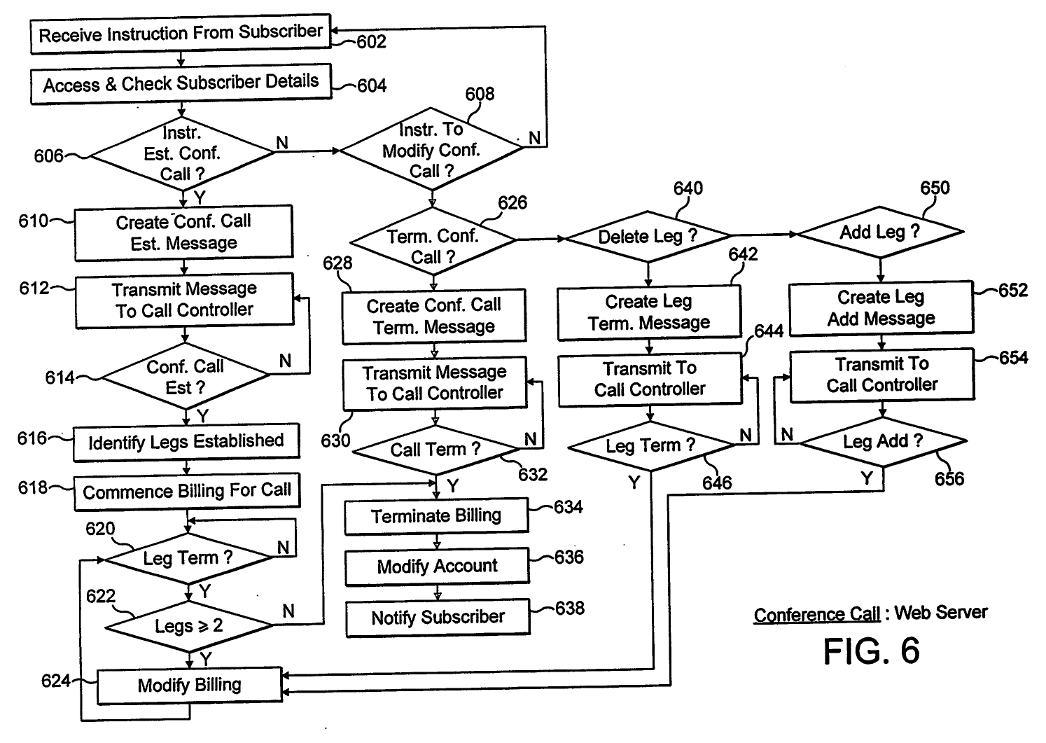

FIG. 6 illustrates the steps for establishing a conference call at a web server in the architecture of FIG. 1 in accordance with the preferred embodiment;

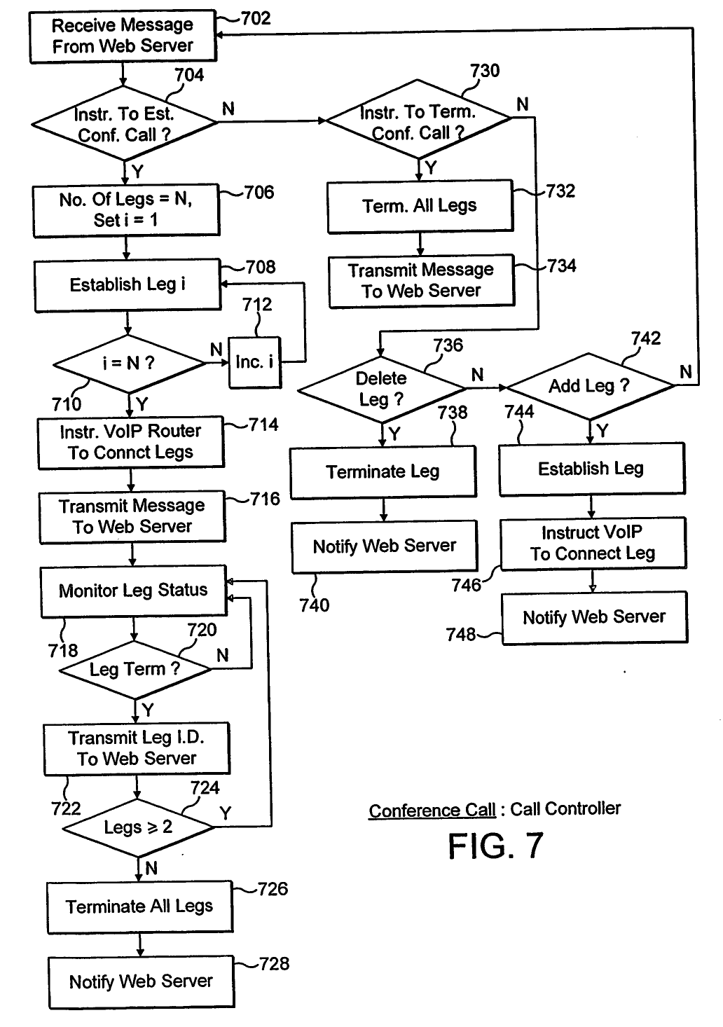

FIG. 7 illustrates the steps for establishing a conference call at a call control server in the architecture of FIG. 1 in accordance with the preferred embodiment;

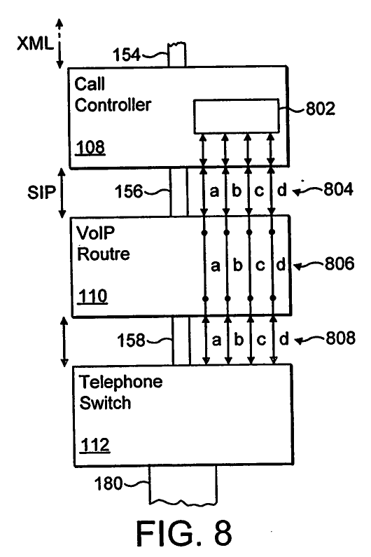

FIG. 8 illustrates in more detail the connection of a conference call in the preferred system architecture of FIG. 1; and

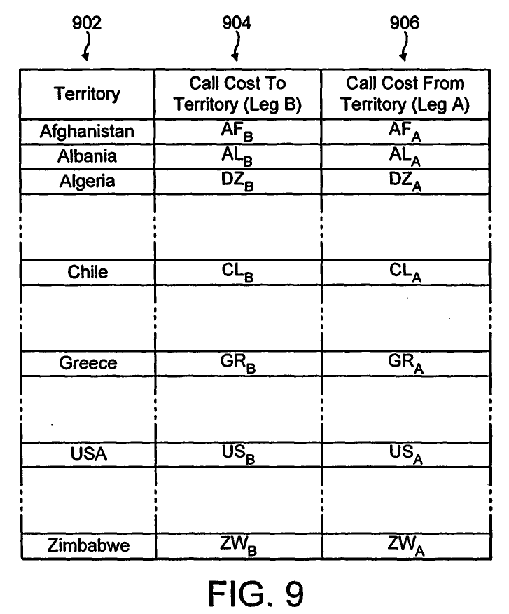

FIG. 9 illustrates the selection of costing for a call in accordance with a preferred embodiment.

The invention is described herein by way of reference to a particular preferred environment. Such environment is presented only for the purpose of understanding the present invention.

Referring to FIG. 1, the infrastructure or system architecture 102 in accordance with a preferred embodiment of the present invention comprises a web server 106, a call controller or call control server 108, and a voice over IP (VoIP) router 110. The web server 106 is connected to a database or plurality of databases, represented by databases 116 and 118, via a communication link 160. The web server 106 is connected to one or more clients, via input devices, as represented by communication links 138, 140, 150, 192 and 148.

The present invention is not limited to any particular client or user input device. Five different types of client or user input device are illustrated in FIG. 1. The present invention may be implemented with only one of such clients or user input devices. Furthermore, the present invention may be implemented with different types of clients or user input devices not shown in FIG. 1.

A first example client illustrated in FIG. 1 is an e-mail user 124. In order to interface the e-mail user 124 to the web server 106, a SMTP-HTTP adaptor 120 is provided. Thus a communication link 194 is provided between the e-mail user 124 and the SMTP-HTTP adaptor 120, and a communication link 138 is provided between the SMTP-HTTP adaptor 120 and the web server 106.

A second example client is a web user 126, which is connected directly to the web server 106 via communication link 140.

A third example client is an SMS user 128. The SMS user 128 is connected to an SMS gateway 136 via communication link 142. The SMS gateway is connected to an SMS proxy 122 via a communication link 144. The SMS proxy 122 is connected to the web server 106 via a communication link 150.

A fourth example client is a SOAP HTTP application 130. The SOAP HTTP application 130 is connected to the web server 106 via a communication link 192.

A fifth example client is a WAP user 132. The WAP user 132 is connected to a WAP gateway 134 via a communication link 146. The WAP gateway 134 is connected to the web server 106 via a communication link 148.

The operation of the various clients in accordance with a preferred embodiment of the invention, and their interconnection with the infrastructure in accordance with the preferred embodiments of the invention, is described further hereinbelow. In terms of the provision of clients, the SMTP to HTTP adaptor 120 and the SMS proxy 122 are provided as part of the system architecture 102 associated with the web server 106 in a preferred embodiment of the present invention. All other Implementations associated with clients are provided by third parties.

The web server 106 is connected to the call controller 108 via a VPN tunnel 114 across the Internet 196 in the illustrative embodiment. Communication link 152 represents the connection from the web server 106 to the VPN tunnel 114, and similarly communication link 154 represents connection from the call controller 108 to the VPN tunnel 114.

It should be noted that the interconnection of the web server 106 and the VoIP router 110 in FIG. 1 is illustrative of an embodiment, and other arrangements may exist. For example, the interconnection may be by way of a QoS (quality of service) assured Frame Relay Service over a Private intranet supplier with a circuit to the call controller 108 from the interconnection 196. When multiple call controllers 108 are provided (see below), and different call controllers are used for different legs of a call, this technique may be used to guarantee the quality of the VoIP transports.

In a further alternative the interconnect 196 between the web server 106 and the call controller 108 may be an ISDN line. In embodiments different types of interconnection may be provided in parallel. For example, the ISDN line may be provided in parallel with the VPN tunnel arrangement of FIG. 1 for back-up purposes.

The call controller 108 is connected to the VoIP router 110 via communication link 156. The VoIP router 110 is connected to a telephone switch 112 via communication link 158. The telephone switch 112 is in the public switched telephone network (PSTN) domain. In the embodiments shown, the telephone switch 112 is in the domain of a PSTN 188. The telephone switch 112 is provided with a plurality of communication links generally illustrated by reference numeral 180, which connect to a plurality of carriers generally illustrated by 182. The communication links 180 and the carriers 182 exist in the PSTN domain 188.

The web server 106, in conjunction with the databases 116 and 118, form the centralised user interface of the preferred architecture. On the other side of the VPN tunnel, the call controller 108 and the VoIP router 110 together form the PSTN interface 176, which more generally can be referred to as a point of presence (POP) together with the PSTN switch 112.

Thus the architecture of the present invention can generally be considered to consist of a controlling point of presence interconnected to a switching point of presence. In embodiments, as described further hereinbelow, both the switching and controlling points of presence may comprise multiple points of presence.

As mentioned, in further embodiments, there may be provided a plurality of PSTN interfaces, or switching POPs, as represented by PSTN interface 174 in FIG. 1. As can be seen in FIG. 1, PSTN interface 174 connects with the web server 106 via a further VPN tunnel 162, which has a communication link 164 to the web server 106 and a communication link 166 to a further call controller 168. It should be noted that the elements 162, 164, 166 in FIG. 1 are illustrative of the functionality of an embodiment of the invention. In effect, these elements are the same elements as elements 196, 152, 154, but connected to a different location, i.e. call controller 168. The call controller 168 interfaces to a VoIP router 169 via a communication link 170, which in turn communicates with a further telephone switch 178 via a communication link 172. The telephone switch 178 is associated with a further PSTN domain 190, including a plurality of communication links 184 from the telephone switch 178 to a plurality of carriers 186.

The operation of the infrastructure of FIG. 1 will be further described hereafter in detail.

The principle of the operation of the infrastructure in accordance with the present invention is for a client or user, preferably a client or user subscriber, to provide the web server 106 with a request detailing a telephone connection which is to be established. In a two-party call, this will be the identity of a telephone number from which the call is to be established, and a telephone number to which the call is to be established to. In a conference call, this will be a number from which the call is to be established, and a plurality of numbers to which the call is to be established to. The details of the telephone connection to be established may be inherent or explicit in the request, as is discussed further hereinbelow.

The web server 106 then provides details of the parties to which the call is to be established to the call controller 108, which controls the VoIP router 110 to establish such calls. The VoIP router 110 establishes the call connections through the telephone switch 112. In a two-party call, the connection of the calls is made in the VoIP router 110. In a conference call, the connection of the parties is made in the call controller 108 via the VoIP router 110.

The web server 106 preferably supports the operation of the infrastructure in accordance with embodiments of the present invention. The databases 116 and 118 preferably store details of registered subscribers to the service supported by the infrastructure. This may include information which can be used by the web server 106 to validate a request for supporting a call connection.

Techniques for subscriber registration are well-known in the art, and one skilled in the art will be familiar with the implementation of such techniques. On registering wth the service, as will be further described herein a subscriber preferably provides details of the telephone numbers with which they wish to utilise the service. This may be a home telephone number, a work telephone number, a mobile telephone number etc. In a preferred embodiment, an authentication procedure is provided as part of the registration process, in order to validate the telephone number. For example, as part of the registration process, using an on-line form presented on a screen of a computer, the new subscriber is required to enter the telephone number from which services are to be established. As part of an authentication procedure, once this form is submitted, the system telephones that number, and plays a recorded message requesting a PIN number to be entered in the keypad of the phone. The PIN number is simultaneously displayed on the computer screen, and the new subscriber reads the number off the screen and enters it into the keypad of the phone. Responsive to detection of the correct PIN number, the system validates the subscription process. This is a one-time event on subscription. This process may be repeated for every telephone number provided by a subscriber and which is to be used as a basis of service initiation. It may also be repeated whenever the subscriber wishes to add a new w number to their subscription or remove a number from their subscription.

On registration, as well as providing the telephone numbers which may be used for initiation or origination of the service, the user may provide telephone numbers to form their own directory, together with ‘short codes’ to simplify system use. For example, a user may provide the numbers stored in theiur mobile phone memory, together with the names associated with such numbers. When a call is initiated, as described below, rather than providing the actual number of the called party the subscriber may simply provide a name, or short-code.

The registration process preferably takes place through access to a website hosted by the web server 106. However the invention is not limited to this specific form of registration process, and other means for registration may be provided. Further once a subscriber is registered, the service itself may be accessed by any means of access, and is not limited.

The access by clients or users to the web server 106, using one of the five described preferred client interfaces, is further described hereinbelow. It should be noted that the purpose of the service is to provide establishment of a communication between at least two end-points, comprising establishment of at least one telephone call. In a preferred embodiment, the end-points are two parties to a telephone call. In alternative embodiments, one end-point may be a service provider, such as a music service provider, news service provider, or messaging service provider.

The subscriber, or party requesting establishment of the call, may not necessarily make the request for establishment of a communication from a device from which they wish to make the telephone call. Thus the client may provide a calling number and a called number (or service identifier) to the web server 106 (explicit mode). The calling number is preferably a number provided by the subscriber on registration. Alternatively the client may simply provide the called number (or service identifier), the calling number being by default the number from which the request is made (inherent mode).

The request may not include any numbers. For example if a caller makes a request using their mobile phone, but wants the call to be established using their home phone (the home phone number being the calling number), they may simply include the command ‘home’ in the request. Similarly if the subscriber has established a directory with their subscription, rather than including the called number in the request, they may include the associated short code, which may be the name of the person to be called, e.g. ‘John’.

As well as establishing calls to specific called numbers, the service may also be used to establish calls to services. In one embodiment, a subscriber can initiate public directory dialling of a call. For example, if a subscriber wishes to contact a particular organisation or service, but does no have that number, that can simply text the name of the organisation, which is mapped to a number from a public directory. For example, the text message ‘IBM’ may initiate a call to a general IBM enquiries number. The service may be adapted to introduce a location specific aspect. For example, based on the location of the origination number, the name may be mapped to a number for that organisation determined to be proximate to the location number. For example, a subscriber sending a request identifying a company name and a calling phone number, e.g. home phone number, may be connected to the phone number for that company nearest to the subscriber's home, on the basis of area code. This may be quite general, e.g. based on country of origin, or more specific, e.g. based on town. This technique may be further refined such that a subscriber may include details of a location in the request. For example, a text message may include ‘IBM’, followed by a postcode (ZIP code), name of a town or city, or part of a postcode or name. For example, if a subscriber is in the postal district SW1 in London, they may text the message ‘Dominos SW1’, and be connected to the local Dominos pizza outlet for SW1.

The service are therefore made from clients or users whose subscription details are stored in the databases 116, 118. The subscription details may include credit details, e.g. if the user has a credit limit, or is a pre-paid or post-paid user. As discussed above, the subscription details may also include a store of numbers with tags, e.g. the subscribers home, work and mobile telephone numbers tagged with labels ‘home’, ‘work’, ‘mobile’. In this way, as will be described hereinbelow, the user may provide the web-server with a tag rather than a number. The database 116, 118 may, in a similar manner, contain a subscriber phone directory with a tag for each number.

Subscribers may register for the service in a number of ways. As known in the art, a subscriber may register via a website interface associated with the web server 106. The subscription mechanism using a website will be familiar to one skilled in the art. The website associated with the web server preferably has multi-lingual options and multi-time zone options so that the system operates in local language and time, and processes locally received messages based on local time. All subscriber records preferably show call records in local time and billing records in local currency. The access to the website may be indirect, for example through a local agent acting as a trusted party between a subscriber and the web server 106 host.

The preferred embodiments below are described in the context of a system operated by Callkey, having a website address of www.callkey.com through which users may subscribe to Callkey services.

In a preferred embodiment, the e-mail client or user 124 sends an e-mail to an address of the form 441624823833@call.callkey.com. In an alternative, rather than sending a number a short code may be sent of the format, for example, john@callkey.com. The short code ‘john’ could then be looked-up in the subscribers personal directory to find the specific number to call for ‘john’.

The e-mail may further be modified to define particular functions. For example:
@billing.callkey.com may be used to obtain a current statement
@home.callkey.com may be used to utilise the subscribers default home origination number
@work.callkey.com may be used to define the subscribers default work origination number
@mobile.callkey.com may be used to define the subscribers default mobile origination number
@sms.callkey.com may be used to send an SMS message rather than establish a call

Regardless of its format, this e-mail is delivered from the client's workstation (or other e-mail tool) to the local mail server, which in turn users the DNS system to discover the IP address of the host processing mail for the call.callkey.com domain by way of an MX record lookup. The MX record will direct the mail server to the IP address of the SMTP-HTTP adaptor 120. The mail server then delivers the message using SMTP to the SMTP-HTTP adaptor 120. Such processing of an e-mail is well-known in the art. The message is then forwarded to the web server 106 using HTTP. The SMPT-HTTP adaptor 120 is preferably a Windows 2000 service which monitors port 25 and accepts the parses incoming mail messages according to the SMT protocol [RFC821] as known in the art. The service delivers the message to the web server 106 at a pre-configured URI using the HTTP protocol [RFC2616] as known in the art.

The web server 106 preferably uses the “from” address extracted from the e-mail to identify the user, and thereafter checks the user subscriber status.

In the case of a web user client 126, the client interfaces with the website associated with the web server 106. Upon connecting to the site, the system uses HTTP authentication to identify the user via a user name/password pair, which is checked in the databases 116, 118. The access of a web user client to a web server via a web interface is well-known in the art.

In the case of an SMS user client 128, the SMS user sends an SMS message to the local SMS service centre, addressing the message to a predetermined number. The message is routed to the SMS gateway 136 provider, which delivers the message to the SMS proxy server 122 within the infrastructure 102 using a proprietary protocol. The SMS proxy server 122 then delivers the message using HTTP to the web server 106.

In the example of a SOAP/HTTP application client 130, a SOAP-compliant application makes a request to the servers by interpreting a WSDL [W3C] resource, and forming a valid request containing the details of the request. This is delivered to the web server 106 over HTTP using communication link 192 according to the SOAP [W3C] convention.

In the case of a WAP user client 132, the WAP user submits a request via a third party WAP gateway 134, which in turn forwards requests to the web server 106 using HTTP.

Regardless of the client user, the web server 106 interprets and processes instructions received from the client device or gateway. The request from a client is for a call to be placed, modified or terminated.

The request from the subscriber may, in one embodiment, simply identify the number to which the call is to be made. The number from which the call is to be made may be determined based on the source of the request, or by identifying the source of the request to a default number in the subscribers record in the database. For example if the request is by SMS, the default calling number may be taken to be the subscribers mobile number. If the request is by e-mail, the default calling number may be the subscriber's home telephone number. In other embodiments, the subscriber request may specifically include the calling number, as described hereinabove.

Responsive to a request, the web server 106 forms an XML description of the action, which is forwarded to the call controller 108 using HTTP via the VPN tunnel 114 in the described embodiment. The VPN tunnel 114 is a DES-encrypted VPN over the Internet, supported by fire walls. The structure of such a communication channel is understood by one skilled in the art. Typically, the web server 106 resides within the IT hosting facility, and the call controller 108 resides in proximity to the telephony infrastructure. As such, the web server 106 and the call controller 108 are typically geographically separated. As such HTTP is used since it uses TCP, a connection based, inherently reliable transport interface.

Contained within the XML description is a call-back URL. The call controller 108 uses this URL to send back status information to the web server 106 whenever there is a change to a call or one or more of the calls constituent legs, or to acknowledge messages. Thus the URL effectively provides an address for the call controller 108 to correspond with.

The call controller 108 communicates with one or more voice over IP routers, such as VoIP router 110, using a session initiation protocol (SIP) [RFC2543] in combination with the SDP protocol [RFC2327]. The SIP messages (with SDP payloads where appropriate) are sent over TCP to the VoIP router 110. The VoIP router replies with SIP response messages. These messages are reformatted by the call controller 108 as XML messages, and forwarded to the web server 106 as described above.

The establishment of messages using XML and SIP are known in the art, and the implementation of an interface in the call controller 108 to convert XML messages to SIP messages and vice versa will be within the scope of one skilled in the art.

The VoIP router 110 may also generate ad-hoc messages in response to particular events (for example, a call party hanging up). The call controller 108 converts and forwards these messages to the web server 106 in the same way.

In the preferred embodiment, the VoIP router 110 communicates with the telephone switch 112 using QSIG-PRI signalling as known in the art.

As noted, the VoIP router 110 may be one of a plurality of such routers controlled by the call controller 108. The provision of more than one VoIP router is an implementation issue associated with the capacity of the system.

As discussed hereinabove, the web-server 106 may be able to direct requests to more than one call controller, such as call controllers 108, 168. The call controller to which a request is directed may be based upon current usage of each controller. Queuing techniques may be used, the implementation of which are outside the scope of the present invention.

The key to the operation of the infrastructure in accordance with embodiments of the preferred invention is the correct sequencing of communication between layers. This is further illustrated hereinbelow by way of reference to detailed operation.

Referring to FIGS. 2 and 3, in conjunction with FIG. 1, there is illustrated the establishment of a two party call in accordance with a preferred embodiment of the present invention.

FIG. 2 illustrates the process followed in the web server 106. Referring to FIG. 2, in a step 202 the web server 106 receives an instruction from a subscriber, which instruction may be received from any one of the plurality of client/user interface means. In a step 204, the web server then accesses the subscriber details in the databases 116, 118, and makes any necessary checks to ensure the service is available to the subscriber. Thereafter, the web server 106 processes the request made by the subscriber.

In a step 206, it is determined whether the subscriber is requesting the establishment of a call. If the subscriber is requesting establishment of a call, in a step 210 the web server 106 creates a call establishment message in XML format, and then in a step 212 transmits such message to the call controller 208 via the VPN tunnel 114.

In a step 214, the web server 106 monitors for receipt of a message from the call controller 108 confirming that the call has been established. If no such message is received within a particular time period, then the web server may revert to step 212 and retransmit the message to the call controller 108. If after a certain number of retransmissions there is still not received a message confirming establishment of the call, then the attempt to establish the call may be abandoned.

If it is detected in step 214 that the call controller 108 has confirmed establishment of a call, then in a step 216 the web server 106 commences billing for the call. This may include updating the details in the databases 116, 118 for the subscriber to show a start time for the call, and recording therewith the calling and called numbers, the charge rate, and current call cost.

Thereafter in step 218, the web server 106 monitors for a message from the call controller 108 that the call has been terminated. On receipt of a message from the call controller 108 that the call is now terminated, in a step 226 the web server 106 terminates the billing. The subscriber's account is then modified in step 228. The modification of the account may include adding an end time to the information associated with the call, and calculating a cost for the call in accordance with the preferred embodiment, as described hereinbelow with reference to FIG. 9. In a preferred embodiment, in a step 230 the subscriber is then notified by the web server 106 of the cost of the call. This may, for example, be by way of SMS message to the subscriber.

The billing of the call to the subscriber may be in accordance with any conventional billing method. For example a monthly invoice, automatic debiting from a bank account or credit card, deduction of credit.

It is further possible for the calling party to terminate the call by request to the web server 106. On receipt of an instruction, the web server as shown in FIG. 2 first establishes whether the instruction is to establish a call in step 206. If the instruction is not to establish a call, then in step 208 it is determined whether the instruction is to terminate a call. If the instruction is to terminate a call, then in step 220 a message to terminate the call is created, and then in step 222 such message is transmitted to the call controller 108. In step 224 the web server 106 monitors to determine whether the call controller 108 acknowledges the message to terminate the call. If such message is not acknowledged within a certain time period, then the procedure reverts to step 222 and the terminate message is retransmitted. On receipt of confirmation of termination of the call in step 224, the steps 226, 228 and 230 are repeated as described hereinabove.

Thus, with reference to FIG. 2 there is described a preferred implementation of a process for establishing and terminating a two-party call at the web server 106 in a preferred system architecture.

Referring to FIG. 3, there is now described a preferred implementation for establishing and terminating a two-party call at the call controller or call control server 108 in accordance with a preferred embodiment of the present invention, complimentary to the web server process of FIG. 2.

In a step 302, the call controller 108 receives a message from the web server 106. In a step 304, the call controller 108 then determines whether the request is an instruction to establish a call. If the instruction is to establish a call, then in a step 306 the call controller 108 establishes a first leg of the call, termed “leg A”, which is preferably to the calling party. This leg is established by the call controller 108 instructing the VoIP router 110.

Thereafter, in a step 308, the second leg of the call is established, termed “leg B”, preferably being the leg of the call to the called party. The call is established by the VoIP router 110 under control of the call controller 108.

After establishment of the two legs, in a step 310 the call controller 108 instructs the VoIP router 110 to connect the two legs of the call together. The two legs of the call are connected together internally in the VoIP router 110.

In this respect, reference is now made to FIG. 4.

Referring to FIG. 4, it can be seen that the VoIP router 110 establishes a call from node 408 to the telephone switch 112 via link 404, and establishes a call from node 406 to the telephone switch 112 via link 402. This corresponds to leg A and leg B. The telephone switch 112 connects each of the calls on links 404 and 402 to the respective ones of the calling party and the called party via the PSTN. The VoIP router 110 in addition internally connects the nodes 408 and 406 as illustrated by the dash line 410.

The VoIP router is thus used to connect the legs of the call in the IP domain. The request for the calls from the VoIP router 110 to the telephone switch 112 is via T1 connections on the communication links 158, as known in the art, which are PRI Interfaces. The two legs of the call are collated internal to the VoIP router 110.

Thus the two legs of the call are connected in the IP domain with IP routing under control of an SIP session.

This is advantageous over the traditional use of a telecommunication switch for connecting the calls such as in the prior art discussed in the Background to the Invention. When a VoIP router is used to pre-establish the calls and then instruct the onward switch to only place the calls but not blend them, the calls themselves are not confined to the PSTN environment. As such, they can be routed to completely physically and geographically distinct locations by virtue of the fact that they are encapsulated as VoIP before the process starts. The use of SIP and a method for starting the call within the router also means that even more dispersion can happen as a result of physically and geographically distinct routers being used in the first place. In essence, each call has its own VoIP identity and can ghave it's own routint path.

The use of the VoIP router also offers the advantage of a non-proprietary implementation. The use of of IP routers allows the onward connection to be open, as it uses standardised Q.931 PRI signalling.

After connection of the two legs of the call, in a further step 312 a message indicating establishment of the call is transmitted to the web server 106.

In a step 314, the call controller 108 then monitors each of the legs of the two party call. If in step 316 it is determined that a leg is terminated, then in a two-party call this represents termination of the entire call. If no leg is terminated, then in step 314 the status of each leg continues to be monitored.

In the event that termination of a leg is detected in step 316, then in step 318 the call controller 108 controls the VoIP router 110 to terminate the other leg. Thereafter, in a step 320 the call controller 108 transmits a message to the web server 106 to confirm termination of the call. In a step 322 the call controller 108 monitors for acknowledgement of such message, and if no such acknowledgement is received reverts to step 320 and retransmits the termination message. On detection of receipt of the acknowledgement in step 322, in step 324 the call controller process terminates.

As discussed hereinabove in relation to FIG. 2, a call may also be terminated on instruction from the web server 106, responsive to a request from the subscriber. Thus the call controller 108 may in addition to receiving an instruction to establish a call, also receive an instruction to terminate a call. If in step 304 it is determined that the received instruction is not to establish a call, then in step 326 it is determined whether the instruction is to terminate a call.

If in step 326 it is determined that the instruction is to terminate a call, then in step 328 the call controller 108 controls the VoIP router 110 to terminate both legs of the call. Thereafter, steps 320, 322 and 324 are repeated.

If in step 326 it is determined that the instruction is not to terminate a call, then the call controller 108 may simply return to step 302 to monitor for received messages. In embodiments, the call controller may be able to process further different types of request from the web server 106, such as requests associated with conference calls as described further hereinbelow.

As noted above, in the preferred embodiment all signalling between the web server 106 and the call controller 108 is by XML messages. All signalling between the call controller 108 and the VoIP router 110 is via SIP messages.

A more detailed description of the messaging between the web server 106, the call controller 108, and the VoIP router 110 in accordance with a preferred embodiment of the invention is now described with reference to FIG. 5. In FIG. 5, it is assumed that the call controller 108 interfaces with a plurality of VoIP routers 110, and the first leg of the call is created via one VoIP router 110a, and the second leg of the call is created via a further VoIP router 110b. Whilst such implementation is possible, the preferred implementation is that all legs of a call are established via the same VoIP router.

The preferred implementation described with FIG. 5 illustrates the use of XML messages between the web server 106 and the call controller 108, and SIP messages between the call controller 108 and VoIP router 110.

The web server 106 transmits a place call request message 502 to the call controller 108. Responsive thereto, the call controller 108 transmits an invite (delayed media) message 504 to the VoIP router 110a. The VoIP router 110a returns a 100 trying message 506 to the call controller 108, which in turn transmits an accepted message 508 to the web server 106. Thereafter the VoIP router 110a returns a 183 session progress (with SDP1) message 510 to the call controller 108, which in turn transmits a ringing message 512 to the web server 106. Thereafter the VoIP router 110a sends a 2000K (with SDP1) message 514 to the call controller 108, which in turn sends an answered message 516 to the web server 106. At this stage, the first leg of the call session has been established.

The call controller 108 then sends an invite (with SDP1) message 518 to the VoIP router 110b. VoIP router 10b returns a 100 trying message 520 to the call controller 108, which in turn returns an accepted message 522 to the web server 106. The VoIP router 110b then returns a 183 session progress (with SDP2) message 524 to the call controller 108, which in turn returns a ringing message 526 to the web server 106.

In the preferred embodiment, at this stage the call controller 108 then forwards an acknowledged message ACK (with SDP2) 528 to the VoIP router 110a to acknowledge set up of the first leg of the call. The VoIP router 110b then returns a 200 OK (with SDP2) message 530 to the call controller 108, which in turn returns an answered message 532 to the web server 106. After returning the answered message 532, the call controller 108 returns a joined message 534 to the web server 106 to indicate joining of the two legs of the telephone call, and then forwards an acknowledged message 536 to the VoIP router 110b to complete the set up of the second leg of the call.

Thereafter, a conversation between the two parties takes place as generally indicated by reference numeral 538.

In normal operation, the call is terminated by one party “hanging up”. The party established via VoIP router 110a hangs up, and as such a BYE message 540 is transmitted from the VoIP router 110a to the call controller 108. In turn the call controller 108 transmits a hung up message 542 to the web server 106. The call controller 108 then transmits a BYE message 544 to the VoIP router 110b, and a 200 OK message 546 to the VoIP router 110a. The VoIP router 110b then transmits a 200 OK message 548 to the call controller 108, and the session is thus terminated.

FIG. 5 illustrates the preferred sequencing of communication between layers of the infrastructure for the XML and SIP implementation. The correct sequencing of the messages is key to optimising the implementation.

The system infrastructure of the present invention advantageously enables for the implementation of reverse billing for callers who are not subscribers to the service. In order to enable this, a function is preferably utilised, where a subscriber sends an SMS request asking a person, who may not be a subscriber, to call them back by replying to the message. A combination of the recipient's number and one of a pool of MSIDN numbers used to send out the message from the SMS service centre identifies the returning message back to the original sender and the call is established with the billing running in reverse, with the subscriber paying for the call. This is essentially SMS initiated toll-free dialling. This feature establishes a principle by which it is possible to have two way identified SMS messaging through a third party. A preferred implementation of such feature is described in further detail hereinafter.

In a preferred embodiment of this function, a subscriber accesses and logs into the web page hosted by the web server 106 and provided by the service provider. The appropriate function option on the website is selected, and the subscriber is prompted to enter certain information. Such information may preferably include: the recipient number (i.e. the number of the person to which toll-free or reverse charge calling is to be provided); the number to which the eventual call should be connected (i.e. the called number for the recipient), typically the subscriber's number; and an expiry date or total number of usages. In one embodiment the recipient will be able to make the toll-free calls for a certain time window (hours, days, week, etc.). In another embodiment the recipient will be able to make toll-free calls on a certain number of occasions, e.g. as a one-off. It should be noted that the calls are toll-free to the recipient, but charged to the subscriber. It should also be noted that the recipient may only avail of this service in respect of the particular number provided by the subscriber who will be charged. In other embodiments, it is envisaged that the subscriber may provide a plurality of numbers to which the recipient has, from their perspective, toll-free access. The subscriber may also enter text which is to be forward to the recipient, e.g. ‘you cn call me toll-free by replying to this message’.

Following such activation of the fucntion by a subscriber, and entry of the relevant details, the web server 106 allocates an outgoing SMS service number for the service. In a preferred embodiment, the web server is provided with a pool of numbers to use as SMS outgoing service numbers (MSIDNs), for example 50. The web server then selects one of such numbers for use with a particular session. The number of numbers in the pool may be implementation dependent, and the aim is to provide enough such that the outgoing service message number for a particular session, together with the recipient number, form a unique combination. As will be apparent from the following, a unique identifier is essential. Other means for providing unique identification may be used.

This selected MSIDN and recipient number is stored together with the other details provided by the subscriber in a call record.

The web server 106 then initiates a text message to the recipient, using the recipients number. The text message will originate from a number being the outgoing SMS service number allocated to the session. The text message includes the text provided by the subscriber. This text message is sent to the recipient in the normal way, through an SMS service centre (Text Gateway—not shown in FIG. 1) to which the web server 106 is connected via the SMS proxy 122. The SMS proxy 122 instructs the SMS service centre as to the MSIDN which should be used for sending a particular message. The control of the MSIDN of a text message in such a way is known in the art.

On receipt of the text message, the recipient reads the message and replies with a blank message. The recipient need only select the reply option when reading the message, and need not enter any text.

This reply message is therefore sent from the recipient to the SMS service number for the session, i.e. the MSIDN associated with the message received by the recipient. This message is received at the SMS service centre and routed to the SMS proxy 122. The message received by the SMS proxy 106 includes the number from which it was sent (the recipient number), and the MSIDN to which it was sent.

The web server then receives the message by interrogating the SMS proxy 122, and extracts the sender number and the MSIDN to compare it with the recipient number and MSIDN pairs stored in the database 116, 118, and retrieve the details of the session. Thereafter the web server 106 preferably initiates establishment of a call in accordance with the techniques described in above. In this arrangement, the calling party is the recipient, and the leg A is established toward the calling party. The called party is the subscriber, or a destination number nominated by the subscriber and the leg B is established toward the subscriber. However, the B-leg party, i.e. the subscriber, is billed.

The described technique may also be used for recipients identified by the subscriber by an e-mail address or url address. The web server sends a message to the stated address, and the recipient returns a reply including the telephone number which may be used for establishing calls.

In the above described embodiments, with reference to FIGS. 2 to 5, there has been described the implementation of the present invention in an example where a two party call is established. The principles of the present invention may also be used advantageously to establish a multi-party call, i.e. a conference call. The establishment of a conference call in accordance with a preferred embodiment of the invention is now described with reference to FIGS. 6, 7 and 8.

Referring to FIG. 6, as described hereinabove with reference to FIG. 2 in a step 602 the web server 106 receives an instruction from a subscriber. In a step 604, using the databases 116, 118 the web server 106 accesses and checks the necessary subscriber details before further processing the request.

In a step 606, it is determined by the web server 106 whether the request relates to an instruction to establish a conference call. If the instruction is to establish a conference call, then in a step 610 the web server 106 creates a conference call establishment message, and then in step 612 transmits such message to the call controller 108.

In step 614, it is determined whether the call controller 108 has responded to the web server 106 with a confirmation message that the conference call has been established. If not, then the transmission of the message in step 612 may be repeated. If after a predetermined number of transmissions the call is not established, then the attempt to establish the conference call may be terminated.

If in step 614 it is determined that the conference call has been established, then in a step 616 the web server 106 identifies the legs of the call that have been established. Preferably, the call controller 108 provides the web server 106 with an identity of the legs of the call established, in case one or more of the plurality of legs desired are not established. In a step 618 the web server 106 can commence billing for the conference call in dependence on those legs established.

In a step 620, the web server 106 then monitors for detection of a message from the call controller 108 advising that a leg of the conference call has been terminated. If a leg is terminated, then in a step 622, the web server determines whether the number of legs remaining in the conference call is greater than or equal to 2. If the number of legs is greater than or equal to 2, then the conference call is not to be terminated. In a step 624, the web server 106 therefore modifies the billing of the conference call, to adjust for the terminated leg, and then returns to step 620 to monitor for messages notifying leg termination.

If in step 622 the number of legs remaining is determined to be not greater than or equal to 2, then there are not sufficient legs established to support a telephone call. Therefore in step 634 the web server 106 terminates the billing, in step 636 the web server modifies the subscriber's account, and then in step 638 notifies the subscriber. Steps 634, 636, 638 correspond to steps 226, 228, 230 respectively of FIG. 2.

In accordance with a preferred embodiment of the present invention, a subscriber is in addition able to modify a conference call after it is established. The modification may be to terminate the conference call, to add a call to the conference call, or delete a call from the conference call. As shown in FIG. 6, if it is determined in step 606 that the instruction received from a subscriber is not to establish a conference call, then in step 608 it is determined whether the instruction is to modify a conference call.

If the instruction is to modify a conference call, then in step 626 it is determined whether the instruction is to terminate the conference call. If so, then in step 628 a conference call termination message is created, and in step 630 such message is transmitted to the call controller 108. In step 632 it is determined whether an acknowledgement is received from the call controller. If not, the process reverts to step 630 and the message is retransmitted.

On confirmation of termination of the conference call in step 632, the process moves on to step 634, and the step 634, 636 and 638 are performed as described hereinabove.

If in step 626 it is determined that the instruction received is not to terminate the conference call, then in step 640 it is determined whether the instruction is to delete a leg of the conference call. If so, then in step 642 a terminate leg message is created and transmitted to the call controller 108 in step 644. In step 646 receipt of an acknowledgement of such message from the call controller is monitored. If no acknowledgement is received, the process reverts to step 644 and the message is re-transmitted. If an acknowledgement is received, then the process moves on to step 624 as described hereinabove.

If in step 640 it is determined whether the message received is not to delete a leg, then in step 650 it is determined whether the instruction is to add a leg. In such case, in step 652 an additional message is created, and transmitted to the call controller in step 654. In step 656 monitoring is carried out for acknowledgement message from the call controller that the additional leg has been added. If no acknowledgement is received, the process reverts to step 654 and the message is re-transmitted. On receipt of an acknowledgement of the addition of the leg, the process moves on to step 624 and billing is modified as described hereinabove, with the addition of a leg.

In FIG. 6 there has been described the implementation of the procedures of the web server in relation to a preferred establishment and modification of a conference call. Referring to FIG. 7, the equivalent procedures implemented in the call controller 108 are described.

In a step 702, the call controller 108 receives a message request from the web server. In step 704, it is determined whether such message is an instruction to establish a conference call.

If the message is an instruction to establish a conference call, then in step 706 the number of legs to be established is set equal to N, and a variable i is set to 1. In a step 708, leg i is then established. In a step 710, it is then determined whether i is equal to N. If i is not equal to N, then in a step 712 i is incremented, and then in a step 708 leg i is established. Thus the steps 708, 710, and 712 are repeated until i is equal to N, i.e. until all legs of the call are established.

Preferably, an error detector is built in to step 708, in the eventuality that it is not possible to establish a particular leg. In such eventuality, the process moves on to steps 710 and 712, and a log is made of the failure to establish a particular leg.

After all legs are established in 710, or all legs with the exception of those in error are established, in step 714 the call controller 108 instructs the VoIP router 110 to connect the N legs. Referring to FIG. 8, the connection of the N legs in order to implement a conference call in accordance with a preferred embodiment of the present invention is illustrated. As can be seen in the example of FIG. 8, the legs of the call in an example where N=4 are established between the VoIP router 110 and the telephone switch 112 on respective connections 808a-808d. Within the VoIP router 110, the connections 808a-808d are connected from one side of the router to the other side of the router via respective connections 806a-806d, such that the connections are presented on the side of the VoIP router which connects to the call controller 108. The call connections are then connected to the call controller 108 via connections 804a-804d. The call controller then internally connects the connections on lines 804a-804d to a mixer block 802, and mixes the four call connections. Although only four call connections are shown in FIG. 8, for a conference call the number of calls may be three or more, the limitations of the implementation only being due to the provision of resources in terms of the numbers of VoIP routers and connections available, or telephone switches available.

On establishment of the conference call, in step 716 the call controller 108 transmits a message to the web server 106, to confirm establishment. This message preferably confirms the identity of the established legs to the web server 106.

In a step 718, the call controller 108 monitors the status of the various legs. If in a step 720 a leg is terminated, then in a step 722 a message is transmitted to the web server 106, identifying the terminated leg. Otherwise, after step 720 the process reverts to step 718.

After termination of a leg and transmission of the message in step 722, in a step 724 it is determined whether the number of legs remaining is greater than equal to 2. If this condition is satisfied, then the process returns to step 718. If there are not greater or equal to 2 legs remaining, then in a step 726 all legs are terminated and in a step 728 the web server 106 is notified of the termination of all legs.

If in step 704 it is determined that the message received is not an instruction to establish a conference call, it is determined whether it is an instruction to terminate a conference call in step 730. If the instruction is to terminate a conference call, then in step 732 all legs are terminated, and in step 734 confirmation of the termination of all legs is transmitted to the web server 106.

If in step 730 it is determined that the instruction is not to terminate a conference call, then in step 736 it is determined whether the instruction is to delete a leg of the conference call. If the instruction is to delete a leg of the conference call, then in step 738 the appropriate leg is terminated, and then in step 740 the web server is notified.

If in step 736 it is determined that the instruction is not to delete a leg, then in step 742 it is determined whether the instruction is to add a leg. If the instruction is to add a leg, then in step 744 the appropriate leg is established, in step 746 the call controller 108 instructs the VoIP router 110 to connect the leg to the conference call, and then in step 748 the call controller 108 notifies the web server 106 appropriately.

Whilst the establishment and control of a conference call has been described herein separate to establishment and control of a two-way call, it will be understood by one skilled in the art that they may be combined. In particular a two-way call may become a conference call (i.e. an n-way call) and a conference call (n-way call) may become a two-way call. As has also been described herein, a call may be established to a service provider rather than another party, which may be considered to be a one-way call. In a similar manner, a one-way call may be come a two-way or n-way call.

Further, a user may be invited to become a party to a conference all by way of an SMS message, using the technique described hereinabove for toll-free telephone usage at the expense of the subscriber or initiator of the conference call.

The principles of operation of the architecture of a system in accordance with a preferred embodiment of the present invention having been described, the principles of call billing in a preferred embodiment are now described.

Referring to FIG. 9 there is illustrated the billing principle of calls established in accordance with the architecture of FIG. 1.

For a two-party call, the call cost is based on a cost associated with the first leg (leg A) and a cost associated with the second leg (leg B). In a preferred embodiment, the call controller 108 and VoIP router 110 are located at a single point, in a preferred implementation in New York. As such, the two legs of the call for a two-way call are established based on call made from New York. Thus the calling party is called from New York and the called party is called from New York. The cost of the call to the called party, leg B, is based on the fixed cost of a call to that territory from New York. Such fixed costs may vary from time to time to take into account variations in costs, including variations in competitor costs.

The cost of the call to the calling party, leg A, can be considered to be the cost of making a call from a particular territory. This cost is not based on the cost of making a call from New York to that territory, but rather a cost which is based on competitor costs of making a call from that territory. This cost may again vary in accordance with competitor variation in charges.

Thus, by establishing both calls of a two-way party call from a geographical location which ensures low cost calls, a call can be established at a low cost, relative to making such a call directly from the country of origin of the call.

FIG. 9 effectively illustrates the charging table stored in the charging database for charging calls established in accordance with the inventive infrastructure. However such charging techniques may also be applied to other infrastructures, and are not limited to being specifically applied in the infrastructure described hereinabove.

As shown in FIG. 9, the charging table comprises three columns, a column 902 listing all territories from which calls can be made or to which calls can be made to, a column 904 listing the call cost of making a call to a territory (i.e. the cost of leg B), and a column 906 listing the call cost of making a call from a territory (i.e. the cost of leg A). Thus for each territory, there is defined two costs, the cost of making a call from, and the cost of making a call to. Typically the costs are per minute or per second charges. Considering an example where a subscriber using the above described infrastructure and being resident in Chile, wishes to place a telephone call to a party based in Greece. In accordance with the present invention as described hereinabove, a call is established from the call controller in New York to Chile (leg A), and a call is established from the call controller in New York to Greece (leg B). The cost of the call is therefore based at a rate of CL_{A} for leg A, and GR_{B} for leg B. The minimum cost of leg A is the cost of making a call from New York to Chile. In practice, competitor services for establishing long-distance calls from Chile will be significantly more expensive than this, and therefore the cost of the leg A call is increased so as to be in the region of competitive call charges, but still being the cheapest of the available charges. The cost of leg B is simply the cost of placing a call from New York to Greece.

In embodiments, multiple call controller and VoIP router combinations 176 may be provided at multiple locations, and requests from the web server address to appropriate ones of such according to predetermined configurations. Multiple call controller and VoIP router combinations 176 may be connected via a common backbone.

The web server 106 is preferably located in a different geographical site to that of the call controller and VoIP router combinations 176.

The present invention has been described hereinabove with reference to particular preferred embodiments. One skilled in the art will appreciate that the invention is hot limited to such embodiments, and variations may exist. The scope of protection afforded by the invention is defined by the appended claims.

Various abbreviations of well-known terminology are described herein. For the avoidance of doubt, a glossary of such terminology is provided below:

Glossary of Terms
SOAP—Simple Object Access Protocol
VPN—Virtual Private Network
HTTP—Hyper Text Transfer Protocol
SMTP—Simple Mail Transfer Protocol
SMS—Short Messaging Service
WAP—Wireless Application Program
PSTN—Public Switched Telephone Network
POP—Point of Presence
MX record—Mail Exchange Record
WSDL—Web Services Description Language
XML—Extended Mark-up Language
SIP—Session Initiation Protocol
DES—Data Encryption Standard
TCP—Transport Control Protocol
URL—Uniform Resource Locator
SDP—Session Description Protocol
QSIG-PRI—Q Signalling Protocol over ISDN PRI Interface
PRI—Primary Rate Interface

1. A method of establishing a communication between at least two end-points, comprising: receiving an identifier of a calling number and an identifier of an action; establishing a communication link to the calling number; establishing a communication link in dependence on said action; and connecting the communication links in an IP domain.

2. A method according to claim 1 wherein the step of connecting the communication links is performed by controlling an IP routing device.

3. A method according to claim 2 wherein the IP routing device may establish a PSTN connection to the calling number.

4. A method according to claim 3 wherein the action is to establish a telephone call to a called number, wherein the IP routing device establishes a PSTN connection to the called number and connects the established PSTN connections to the calling number and the called number in the IP domain.

5. A method according to claim 4 wherein the IP routing device is controlled to establish the PSTN connections to the calling party and the called party at terminals thereof, the IP routing device being further adapted to connect said terminals internally.

6. A method according to claim 3 wherein the action is to access a streamed service, wherein the IP routing device connects the PSTN connection to the streamed service in the IP domain.

7. A method according to claim 6 wherein the IP routing device is controlled to establish the PSTN connection to the calling party, the IP routing device being further adapted to route said PSTN connection to a mixing server adapted to receive the streamed service.

8. A method according to claim 3 wherein the action is to establish a PSTN connection to a plurality of called numbers, wherein the IP routing device connects the plurality of called numbers to the calling number in the IP domain.

9. A method according to claim 8 wherein the IP routing device is controlled to establish the PSTN connections to the calling party and the called parties at terminals thereof, the IP routing device being further adapted to route said connections to a mixing server in the IP domain.

10. A method according to any preceding claim wherein the step of receiving an identifier of a calling number comprises identifying the originating number of a request for the action.

11. A method according to any preceding claim wherein step of receiving an identifier of a calling number comprises extracting the calling number from a request for the action.

12. A method according to claim 12 request may contain an identifier which maps to the calling number.

13. A method according to any one of claims 4 to 12 wherein the identifier of the action comprises the called number, the method comprising extracting the called number from a request for the action.

14. A method according to claim 13 wherein the request contains an identifier which maps to the called number.

15. A method according to claim 14 wherein the request message may be received from any one of an e-mail client, a web client, an SMS client, a SOAP/HTTP client, or a WAP client.

16. A method according to any one of claims 2 to 15 IP routing device is preferably controlled using SIP messages.

17. A method according to any preceding claim further comprising receiving a request to establish a call connection at a web server, said request including the identifier of the calling number and the identifier of the action; verifying said request at the web server; transmitting said request in XML message format to a call controller controlling an IP router using SIP message, establishing the communication link to the calling number at the IP router under the control of the call controller.

18. A method according to claim 17 when dependent upon any one of claims 4 to 16 any further comprising establishing the communication link to the called number at the IP router under the control of the call controller, and controlling the IP router to connect the established communication links internally.

19. A method according to claim 17 when dependent upon any one of claims 6 to 16 wherein the IP routing device may route said PSTN connection to a mixing server adapted to receive the streamed service.

20. A method according to claim 17 when dependent upon any one of claims 8 to 16 further comprising establishing communication links to the called numbers at the IP router under the control of the call controller, and controlling the IP router to connect the established communication links to a mixer in the IP domain, and mixing the established communication links under the control of the call controller.

21. A communication element adapted to establish a communication between at least two end-points, comprising: means adapted for receiving a request including an identifier of a calling number and an identifier of an action; means adapted for establishing a communication link to the calling number; means adapted for determining a communication link in dependence on said action; and means adapted for connecting the communication links in an IP domain.

22. A communication element according to claim 21, wherein the request is an XML message, the means adapted for establishing a communication link to the calling number and the means adapted for connecting the communication links in an IP domain comprising control means for transmitting SIP messages to an IP router.

23. A communication element according to claim 22, wherein if the action is to establish a call between a calling party and a called party, the SIP messages instruct the IP router to establish a PSTN connection to each party and connect such connections internally.

24. A communication element according to claim 22, wherein if the action is to establish a call between a calling party and multiple called parties, the SIP messages instruct the IP router to establish a PSTN connection to each party and route such connections to a mixer in the IP domain.

25. A communication element according to claim 22, wherein if the action is to establish a connection for the calling party to a streamed service, the SIP messages instruct the IP router to establish a PSTN connection to the calling party and route such connections to a mixer in the IP domain adapted to receive the streamed service.

26. A communication element according to any one of claims 21 to 25 wherein the element is a switching server.

27. A communication element adapted to control the establishment of a communication between at least two end-points, comprising: means adapted for receiving a request including an identifier of a calling number and an identifier of an action; means adapted for verifying the request, and means adapted to transmit said request in XML format messages to an element for establishing the communication.

28. A communication element according to claim 27 wherein the request comprises a message from any one of an e-mail client, a web client, an SMS client, a SOAP/HTTP client, or a WAP client

29. An IP router adapted to establish of a communication between at least two end-points, the router being adapted to establish a PSTN communication link to a first end-point, establish a communication link to a second end-point, and connect said established communications internally.

30. A communication system adapted to establishing a communication between at least two end-points, comprising: a control server for receiving a request including an identifier of a calling number of one end-point and an identifier of an action, and adapted to transmit said request in XML format in dependence upon said action, a switching control server for receiving the request in XML format; an IP router operating under the control of SIP messages from the switching control server; the IP router being controlled for establishing a first communication link to the calling number of the one end-point; wherein the switching controller further controls the IP router to connect the established communication link to the other end-point.
